(19) United States
(12) Patent Application Publication
(10) Pub. No.: US 2025/0314821 A1
(43) Pub. Date: Oct. 9, 2025

(54) PHOTONIC STRUCTURE AND METHODS OF MAKING SAME

(71) Applicant: TAIWAN SEMICONDUCTOR MANUFACTURING COMPANY LTD., HSINCHU (TW)

(72) Inventors: WEN-SHUN LO, HSINCHU COUNTY (TW); CHUN-HENG CHEN, HSINCHU CITY (TW); YINGKIT FELIX TSUI, CUPERTINO, CA (US); SHIH-FEN HUANG, HSINCHU COUNTY (TW)

(21) Appl. No.: 18/629,970

(22) Filed: Apr. 9, 2024

(51) Int. Cl. G02B 6/122; G02B 6/126; G02B 6/13

(52) U.S. Cl. CPC G02B 6/1228; G02B 6/126; G02B 6/13

(57) ABSTRACT

A photonic structure is provided. The photonic structure includes a base layer with a cladding layer formed thereon and a waveguide coupler, a waveguide transition, a polarization-splitter-rotator and two ports surrounded by a cladding layer. The waveguide transition is formed underneath the waveguide coupler. The polarization-splitter-rotator is extended from the waveguide transition along a first direction and including a combined section extended from the waveguide transition and a splitting section extended from the combined section. The splitting section has a first waveguide extended from the combined section and a second waveguide separated from the first waveguide by the cladding layer. The two ports are extended from the first waveguide and the second waveguide, respectively. The splitting section has a thickness, which is less than a thickness of the combined section, is less than a thickness of the two ports.

### BACKGROUND

Optical gratings are frequently used to couple light between a waveguide and an optical fiber. Due to extremely different dimensions of the waveguide and the optical fiber, direct coupling would incur tremendous light loss. It is thus essential to meticulously design a waveguide light coupling apparatus for light mode field matching to the fiber dimension.

For example, an incoming light to a waveguide is usually in an unknown and arbitrary polarization state, such that a polarization-splitting rotator (PSR) is needed to provide polarization light in either transverse-magnetic (TM) mode or transverse-electric (TE) mode from the optical fiber to the waveguide. The coupling efficiency of a PSR is typically impacted by a polarization dependent loss (PDL) of TE and TM modes, which may result from non-zero fiber angle used to minimize reflections at the interface between fiber and grating. To obtain a semiconductor device with high performance, there exists a need to develop a photonic integrated circuit of efficient optical coupling.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 illustrates a top view of a polarization diversity optical receiver in the photonic structure, in accordance with some embodiments of the present disclosure.

FIG. 2A illustrates a cross-sectional view along line A-A′ of the of the polarization diversity optical receiver shown in FIG. 1, in accordance with some embodiments of the present disclosure.

FIG. 2B illustrates a cross-sectional view along line F-F′ of the of the polarization diversity optical receiver shown in FIG. 1, in accordance with some embodiments of the present disclosure.

FIG. 3 illustrates a cross-sectional view along line B-B′ of the of the polarization diversity optical receiver shown in FIG. 1, in accordance with some embodiments of the present disclosure.

FIG. 4 illustrates a cross-sectional along line C-C′ of the of the polarization diversity optical receiver shown in FIG. 1, in accordance with some embodiments of the present disclosure.

FIG. 5 illustrates a cross-sectional along line D-D′ of the of the polarization diversity optical receiver shown in FIG. 1, in accordance with some embodiments of the present disclosure.

FIG. 6 illustrates a cross-sectional along line E-E′ of the of the polarization diversity optical receiver shown in FIG. 1, in accordance with some embodiments of the present disclosure.

FIG. 7 is a flowchart of a method for forming a polarization diversity optical receiver in the photonic structure in accordance with some embodiments.

FIGS. 8 to 24 illustrate various cross-sectional views of forming the polarization diversity optical receiver in the photonic structure in accordance with some embodiments as described in FIG. 7, in which (a) is a cross-sectional view of the polarization diversity optical receiver corresponding to the cross-section along line B-B′ shown in FIG. 1; (b) is a cross-sectional view of the polarization diversity optical receiver corresponding to the cross-section along line C-C′ shown in FIG. 1; (c) is a cross-sectional view of the polarization diversity optical receiver corresponding to the cross-section along line D-D′ shown in FIG. 1; and (d) is a cross-sectional view of the polarization diversity optical receiver corresponding to the cross-section along line E-E′ shown in FIG. 1.

### DETAILED DESCRIPTION OF THE DISCLOSURE

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 100 degrees or at other orientations) and the spatially relative descriptors used herein may likewise be interpreted accordingly.

As used herein, the terms such as “first,” “second” and “third” describe various elements, components, regions, layers and/or sections, but these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

The present disclosure relates to photonic devices which are made up of different layers. When the terms “on” or “upon” are used with reference to two different layers (including the substrate), they indicate merely that one layer is on or upon the other layer and do not require the two layers to directly contact each other, and permit other layers to be between the two layers. For example, all layers of the photonic device can be considered to be “on” the substrate, even though they do not all directly contact the substrate. The term “directly” may be used to indicate two layers directly contact each other without any layers in between them.

Similarly, the terms “input” and “output” are relative to light passing through them with respect to a given structure, e.g. light enters the structure through the input, and exits the structure through the output. The terms “upstream” and “downstream” are also relative to the direction in which light passes through various components, i.e. the light passes through an upstream component prior to passing through the downstream component.

Silicon photonics is a promising platform for the construction of efficient information processing chips due to its compatibility with complementary-metal-oxide semiconductor (CMOS) technology, low cost, and high yield. Polarization diversity optical receiver is one of important building blocks in silicon-based photonic systems to detect the information with photon signals from optical fibers. In standards, the physical medium is specified as single-mode fibers, which are not designed to maintain the polarization of light. Consequently, polarization diversity is required for optical receivers.

The dimension and shape of each element of the photonic structure are essential for the transmission of photonics. The dimension and shape of the photonic structure of the present invention are designed to eliminate the loss of photonics during propagation.

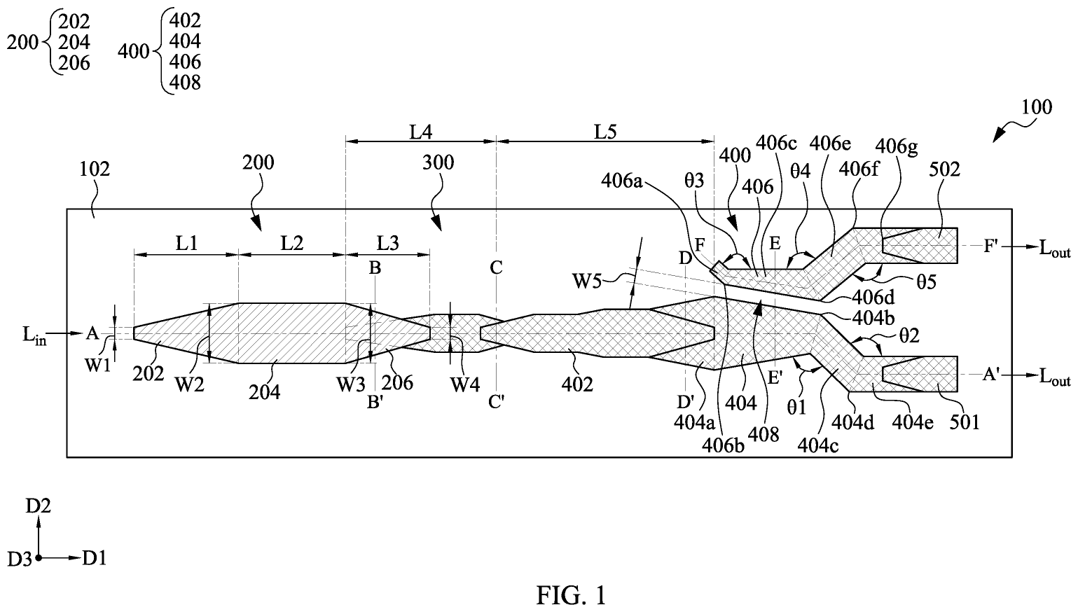

FIG. 1 illustrates a top view of a photonic structure 100 in accordance with some embodiments of the present disclosure. The photonic structure 100 includes a base layer 101, a cladding layer 102 formed on a base layer 101, and a waveguide coupler 200, a waveguide transition 300, a polarization-splitter-rotator 400 and first and second ports 501 and 502 formed in the cladding layer 102.

The base layer 101 include a substrate. The substrate is usually a wafer made of a semiconducting material. Such materials can include silicon, for example in the form of crystalline Si or polycrystalline Si. The substrate can also be made from other elementary semiconductors such as germanium or AL2O₃ (sapphire), or may include a compound semiconductor such as silicon carbide (SiC), gallium nitride (GaN), gallium arsenide (GaAs), indium arsenide (InAs), and indium phosphide (InP), or from other materials such as glass, a ceramic, or a dielectric material. In some embodiments, the substrate may be a silicon-on-insulator (SOI) wafer. An SOI wafer comprises a substrate and an insulating layer (e.g., buried oxide or BOX) formed on the substrate.

The cladding layer 102 is overlaid onto the base layer 101. When the base layer 101 is an SOI wafer, the cladding layer 102 may include oxide, such as silicon oxide. The material forming the cladding layer 102 may be identical to that forming the buried oxide of the insulating layer of the SOI wafer. In some embodiments, the cladding layer 102 may include oxide and serve as the buried oxide of the insulating layer of the SOI wafer.

The waveguide coupler 200 is surrounded by the cladding layer 102 and may confine light based on refractive index contrast between the materials in the waveguide coupler 200 and the cladding layer 102. The waveguide coupler 200 includes an edge portion 202, a waveguide portion 204 and a transition portion 206 arranged along a first direction D1. The waveguide coupler 200 can be made of silicon nitride (SiNₓ), such as Si₃N₄. For reference, silicon nitride has a refractive index of about 1.98. Silicon nitride can be deposited using plasma-enhanced chemical vapor deposition (PECVD) or low pressure chemical vapor deposition (LPCVD) by the reaction of dichlorosilane (SiH₂CL2) with ammonia (NH₃). In some embodiments, silicon nitride may be replaced with other materials with a refractive index from about 1.5 to about 2.3. For example, silicon nitride may be replaced with silicon carbide (SiC) or silicon oxide nitride (SiOₓN_{y}). From the top view as shown in FIG. 1, the waveguide coupler 200 has a symmetrical shape along the axis parallel to the first direction D1.

In some embodiments, the edge portion 202 is located at a front end of the waveguide coupler 200 to receive incident light beam Lᵢₙ containing wavelengths with orthogonal polarization states (including an input TE mode and an input TM mode). The edge portion 202 has a top section with a tapered shape, such as trapezoid and in some embodiments, with an isosceles trapezoid shape. The edge portion 202 has a proximal end receiving the incident light beam Lᵢₙ and a distal end adjacent to the waveguide portion 204. The terminal end has a width W1 and the distal end has a width W2. In some embodiments, W1 may be less than W2. In some embodiments, the ratio of W1 to W2 may be about 1:8 to about 1:1.5. In some embodiments, the ratio of W1 to W2 may be about 1:6 to about 1:2. In some embodiments, the ratio of W1 to W2 may be about 1:6 to about 1:2.5. The edge portion 202 has a length L1. In some embodiments, the ratio of L1 to W2 is about 4:1 to about 1:1. In some embodiments, the ratio of L1 to W2 is about 3:1 to about 2:1.

In some embodiments, the waveguide portion 204 can be integrally formed with the edge portion 202 and receives photons from the incident light beam Lᵢₙ coming from the edge portion 202. The waveguide portion 204 is extended from the distal end of the edge portion 202. The waveguide portion 204 has a thickness, which may be identical to the thickness of the edge portion 202. The waveguide portion 204 may have a top cross section with a four-sided shape, which can be a square, rectangle, diamond, parallelogram and the like. As shown in FIG. 1, the waveguide portion 204 has a top cross section that is a rectangle and has a width, which can be substantially identical to W2 of the edge portion 202. In some embodiments, the width of the waveguide portion 204 is consistent. The waveguide portion 204 has a length L2. In some embodiments, L2 can be substantially identical to L1. In some embodiments, L2 may be greater or less than L1. In some embodiments, the ratio of L2 to L1 can be about 4:1 to about 1:4. In some embodiments, the ratio of L2 to L1 can be about 3:1 to about 1:3. In some embodiments, the ratio of L2 to L1 can be about 2:1 to about 1:2.

In some embodiments, the transition portion 206 can be integrally formed with the waveguide portion 204 and receives photons from the incident light beam Lᵢₙ coming from the waveguide portion 204, so that the incident light beam Lᵢₙ enters the waveguide coupler 200 from the proximal end of the edge portion 202 and propagates along the first direction D1 through the waveguide coupler 200 from the edge portion 202, the waveguide portion 204 to the transition portion 206, toward the waveguide transition 300. The transition portion 206 is used for light transition from SiN material to Si material (that is, the waveguide transition 300). The transition portion 206 has a thickness, which may be identical to the thickness of the waveguide portion 204.

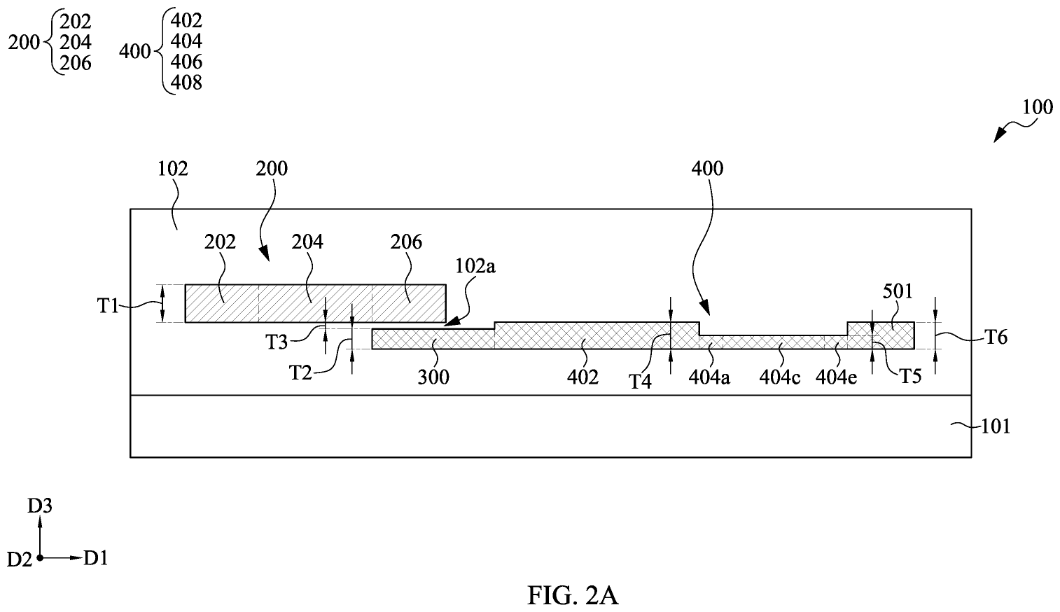

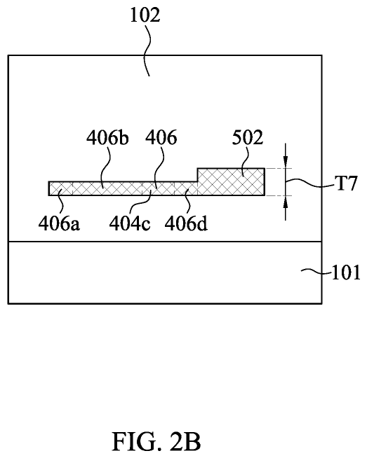

As shown in FIG. 2A, the waveguide coupler 200 has a consistent thickness T1, so that the thickness of the edge portion 202, the thickness of the waveguide portion 204 and the thickness of the transition portion 206 are substantially identical. In some embodiments, the thickness T1 of the waveguide coupler 200 may range from about 150 nm to about 400 nm. In some embodiments, the thickness T1 of the waveguide coupler 200 may range from about 170 nm to about 300 nm. In some embodiments, the thickness T1 of the waveguide coupler 200 may range from about 170 nm to about 250 nm. The transition portion 206 has a top section with a tapered shape, such as trapezoid and in some embodiments, with an isosceles trapezoid shape. The transition portion 206 has a proximal end receiving the incident light beam Lᵢₙ coming from the waveguide portion 204 and a distal end. The terminal end has a width W3 and the distal end has a width W4. In some embodiments, the ratio of W3 to W4 may be about 8:1 to about 1.5:1. In some embodiments, the ratio of W3 to W4 may be about 6:1 to about 2:1. In some embodiments, the ratio of W2 to W1 may be about 6:1 to about 2.5:1. In some embodiments, W3 may be greater than W4. As shown in FIG. 1, W2 is substantially identical to W3 and W1 is substantially identical to W4. The transition portion 206 has a length L3. In some embodiments, L3 may be substantially identical to L1. In some embodiments, L3 may be substantially identical to L2. In some embodiments, as shown in FIG. 1, L3 is shorter than L1 and L3 is shorter than L2. In some alternative embodiments, L3 may be longer than L1. In some alternative embodiments, L3 is longer than L2. In some embodiments, the ratio of L3 to L1 is about 2:1 to about 1:2. In some embodiments, the ratio of L3 to L1 is about 1.5:1 to about 1:1.5. In some embodiments, the ratio of L3 to L2 is about 2:1 to about 1:2. In some embodiments, the ratio of L3 to L2 is about 1.5:1 to about 1:1.5. In some embodiments, the ratio of L3 to W3 is about 4:1 to about 1:2. In some embodiments, the ratio of L1 to W2 is about 3:1 to about 1:1. In some embodiments, the ratio of L1 to W2 is about 2:1 to about 1.5:1.

As shown in FIGS. 1 and 2, the waveguide transition 300 is surrounded by the cladding layer 102 and is formed underneath the waveguide coupler 200. The waveguide transition 300 can be made of silicon. The waveguide transition 300 receives photons from the incident light beam Lᵢₙ coming from the transition portion 206 of the waveguide coupler 200 through the cladding layer 102 and is also used for light transition from SiN material (i.e., the waveguide coupler 200) to Si material. The waveguide transition 300 has a proximal end located underneath the waveguide coupler 200 and has a distal end, which is not covered by the waveguide coupler 200 from the top view. The proximal end of the waveguide transition 300 may be align with the proximal end of the transition portion 206 of the waveguide coupler 200. From the top view as shown in FIG. 1, the waveguide transition 300 has a symmetrical shape along the axis parallel to the first direction D1. Also from the top view, it can be observed that the waveguide transition 300 is partially covered by the waveguide coupler 200. In some embodiments, about ⅙ to about ½ of area of the top of the waveguide transition 300 is covered by the waveguide coupler 200. In some embodiments, about ⅕ to about ½ of area of the top of the waveguide transition 300 is covered by the waveguide coupler 200. In some embodiments, about ¼ to about ½ of area of the top of the waveguide transition 300 is covered by the waveguide coupler 200. In some embodiments, about ⅓ to about ½ of area of the top of the waveguide transition 300 is covered by the waveguide coupler 200. The waveguide transition 300 has a length L4 along the first direction D1. The length L4 may be longer than L1, longer than L2 and also longer than L3, but shorter than the sum of L1 and L2, shorter than the sum of L2 and L3 and also shorter than the sum of L1 and L3. In some embodiments, the ratio of L4 to L3 may be from about 3:1 to 1.1:1. In some embodiments, the ratio of L4 to L3 may be from about 2.5:1 to 1.5:1. In some embodiments, the ratio of L4 to L3 may be from about 2.3:1 to 2:1.

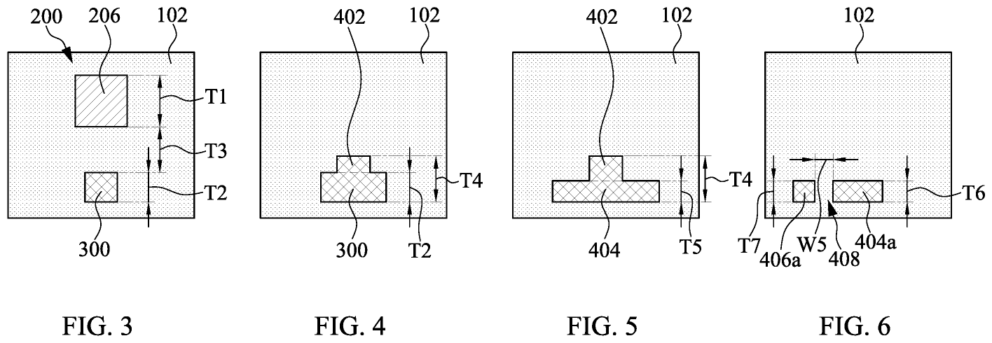

Further in view of FIG. 3, the waveguide transition 300 has a thickness T2, which may be less than the thickness T1. In some embodiments, the ratio of T2 to T1 can be about 1:5 to about 1:1.1. In some embodiments, the ratio of T2 to T1 can be about 1:4 to about 1:1.5. In some embodiments, the ratio of T2 to T1 can be about 1:3 to about 1:2. In some embodiments, the thickness T2 of the waveguide transition 300 may range from about 150 nm to about 280 nm. In some embodiments, the thickness T2 of the waveguide transition 300 may range from about 170 nm to about 250 nm. In some embodiments, the thickness T2 of the waveguide transition 300 may range from about 190 nm to about 240 nm. In some embodiments, the thickness T2 of the waveguide transition 300 may range from about 210 nm to about 230 nm. The waveguide transition 300 is separated from the waveguide coupler 200 along a third direction D3, perpendicular to the first direction D1, by the material for forming the cladding layer 102. In view of FIG. 2A, there is a cladding interlayer 102a formed between the waveguide coupler 200 and the waveguide transition 300. The cladding interlayer 102a has a thickness T3, which is less than T2. In some embodiments, the ratio of T2 to T3 can be from about 10:1 to about 1.5:1. In some embodiments, the ratio of T2 to T3 can be about 8:1 to about 2:1. In some embodiments, the ratio of T2 to T3 can be about 6:1 to about 4:1.

The polarization-splitter-rotator 400 is surrounded by the cladding layer 102 and is integrally formed with the waveguide transition 300. The polarization-splitter-rotator 400 is extended from the waveguide transition 300. The polarization-splitter-rotator 400 can be made of silicon. The polarization-splitter-rotator 400 includes a combined section 402 and a splitting section. The combined section 402 is extended from the distal end of the waveguide transition 300 and receives the photons from the incident light beam Lᵢₙ coming from the waveguide transition 300. The combined section 402 may have a symmetric top view with varied width along the first direction D1 and has a distal transition portion and a proximal mode-evolution portion. The distal transition portion is extended from the distal end of the waveguide transition 300 and is used for light transition from the waveguide transition 300 to the polarization-splitter-rotator 400, which have a difference in thickness. Due to the distal transition portion, which as a tapered shape, the proximal end presents a V shape from the top view as shown in FIG. 1. The proximal mode-evolution portion has a taper shape, which is designed to convert the input TM mode (i.e., a fundamental transverse-magnetic mode, TM₀ mode) into a TE mode (i.e., a first-order transverse-electric mode, TE₁ mode) due to the mode coupling in these two modes while the input TE mode is not converted into other guided mode in the proximal mode-evolution portion.

The combined section 402 has a length L5 along the first direction D1. The length L5 may be longer than the sum of L1 and L2, longer than the sum of L2 and L3, longer than the sum of L1 and L3 and also longer than L4, but shorter than the sum of L1, L2 and L3. In some embodiments, the ratio of L5 to L4 may be from about 2:1 to 1.1:1. In some embodiments, the ratio of L5 to L4 may be from about 5:3 to 1.5:1. In some embodiments, the ratio of L5 to L4 may be from about 4.5:3 to 2:1. Further in view of FIG. 4, the combined section 402 has a thickness T4 that is thicker than the thickness T3 of the waveguide transition 300. In some embodiments, the ratio of T4 to T3 can be about 1.1:1 to about 2.5:1. In some embodiments, the ratio of T4 to T3 can be about 1.5:1 to about 2:1. In some embodiments, the thickness T4 of the combined section 402 may range from about 200 nm to about 350 nm. In some embodiments, the thickness T4 of the combined section 402 may range from about 220 nm to about 320 nm. In some embodiments, the thickness T4 of the combined section 402 may range from about 250 nm to about 300 nm. In some embodiments, the thickness T4 of the combined section 402 may range from about 270 nm to about 290 nm.

The splitting section has an asymmetric Y shape from the top view and includes a first waveguide 404 and a second waveguide 406, which are separated by the cladding layer 102 along a second direction D2, which is perpendicular to the first direction D1 and perpendicular to the third direction D3. Further in view of FIG. 5, the splitting section has a thickness T5, which is less than T4. In some embodiments, the ratio of T5 to T4 is from about 1:3 to about 1:1.1. In some embodiments, the ratio of T5 to T4 is from about 1:2.7 to about 1:1.2. In some embodiments, the ratio of T5 to T4 is from about 1:2.5 to about 1:1.5. In some embodiments, the ratio of T5 to T4 is from about 1:2.0 to about 1:1.8. In addition, the thickness T5 may be equal to or less than the thickness T2. In some embodiments, the ratio of T5 to T2 may be from about 1:2.5 to about 1:1. In some embodiments, the ratio of T5 to T2 may be from about 1:2.1 to about 1:1.4. In some embodiments, the ratio of T5 to T2 may be from about 1:2.0 to about 1:1.5. In some embodiments, the thickness T5 of the splitting section ranges from about 100 nm to about 200 nm. In some embodiments, the thickness T5 of the splitting section ranges from about 120 nm to about 180 nm. In some embodiments, the thickness T5 of the splitting section ranges from about 150 nm to about 160 nm.

The first waveguide 404 extends from the proximal mode-evolution portion of the combined section 402, receives the input TE mode and excites the input TE mode into an output TE mode. The first waveguide 404 has a distal end connecting the proximal mode-evolution portion of the combined section 402 and a proximal end connecting a first port 501 described below. The first waveguide 404 has a first turn 404b and a second turn 404d, so that the first waveguide 404 includes a first region 404a defined between the distal end and the first turn 404b, a second region 404c defined between the first turn 404b and the second turn 404d, and a third region 404e defined between the second turn 404d and the proximal end. The first region 404a has a gradually increased width from the distal end and further has a gradually decreased width toward the first turn 404b. The second region 404c is extended from the first region 404a and is elongated along a direction away from the second waveguide 406, so that the first turn 404b has an angle θ₁ formed between the first region 404a and the second region 404c, which can be from about 90° to less than 180°. In some embodiments, the angle θ₁ can be from about 100° to less than 170°. In some embodiments, the angle θ₁ can be from about 110° to less than 150°. In some embodiments, the angle θ₁ can be from about 120° to less than 140°. The third region 404e is extended from the second region 404c and is elongated along the first direction D1, so that the second turn 404e has an angle θ₂ formed between the second region 404c and the third region 404e, which can be from about 90° to less than 180°. In some embodiments, the angle θ₁ can be from about 100° to less than 170°. In some embodiments, the angle θ₁ can be from about 120° to less than 150°. In some embodiments, the angle θ₁ can be from about 130° to less than 140°.

In view of FIG. 1 and FIG. 2B, the second waveguide 406 is surrounded by a cladding layer 102 and thus is separated from the first waveguide 404 by the cladding layer 102. The second waveguide 406 is used to evolve the TE₁ mode converted from the input TM mode into an output TE mode (i.e., a fundamental transverse-electric mode (TE₀). A connecting strip 408 is formed between the second waveguide 406 and the first waveguide 404, includes the material for forming the cladding layer 102 and has a narrowest width W5. In some embodiments, the ratio of W5 to T5 can be about 2:1 to 1:2. In some embodiments, the ratio of W5 to T5 can be about 1.5:1 to 1:1.5. In some embodiments, the ratio of W5 to T5 can be about 1.3:1 to 1:1.3. In some embodiments, the width W5 may range from about 50 nm to about 220 nm. In some embodiments, the width W5 may range from about 100 nm to about 200 nm. In some embodiments, the width W5 may range from about 130 nm to about 180 nm. In some embodiments, the width W5 may range from about 150 nm to about 170 nm. Due to the decreased thickness T5 of splitting section, the materials for forming the cladding layer 102 can be substantially completely filled in the connecting strip 408 with a decreased aspect ratio, so that photons in the TE₁ mode converted from the input TM mode can be more efficiently pass through the connecting strip 408 from the first waveguide 404. If the thickness T5 of splitting section is thick and thus the aspect ratio is increased, the materials for forming the cladding layer 102 would be difficult to be filled in the connecting strip and some voids may be formed around a bottom of the connecting strip.

The second waveguide 406 has a distal end and a proximal end and includes a first turn 406b, a second turn 406d and a third turn 406f, so that the second waveguide 406 includes a first region 406a defined between the distal end and the first turn 406b, a second region 406c defined between the first turn 406b and the second turn 406d, a third region 406e defined between the second turn 406d and third turn 406f, and a fourth region 406g defined between the third turn 406f and the proximal end. The first region 406a is extended from the distal end and approaching the first waveguide 404. The first turn has an angle θ₃ formed between the first region 406a and the second region 406c, which can be from about 90° to less than 180°. In some embodiments, the angle θ₃ can be from about 100° to less than 170°. In some embodiments, the angle θ₃ can be from about 110° to less than 150°. In some embodiments, the angle θ₃ can be from about 120° to less than 140°. The second region 406c has a gradually increased width from the first region 406a and is the region closest to the first waveguide 404, so that the connecting strip 408 is formed between the second region 406c of the second waveguide 406 and the first region 404a of the first waveguide 404. The third region 406e is extend from the second region 406c and away from the first waveguide 404, so that the second turn 406d has an angle θ₄ formed between the second region 406c and the third region 406e, which can be from about 90° to less than 180°. In some embodiments, the angle θ₄ can be from about 100° to less than 170°. In some embodiments, the angle θ₄ can be from about 110° to less than 150°. In some embodiments, the angle θ₄ can be from about 120° to less than 140°. The fourth region 406g is extended from the third region 406e and is elongated along the first direction D1, so that the third turn 404f has an angle θ₅ formed between the third region 404e and the fourth region 404g, which can be from about 90° to less than 180°. In some embodiments, the angle θ₁ can be from about 100° to less than 170°. In some embodiments, the angle θ₁ can be from about 120° to less than 150°. In some embodiments, the angle θ₁ can be from about 1300 to less than 140°. The fourth region 406g of the second waveguide 406 is parallel to the third region 404e of the first waveguide 404.

The first port 501 is integrally formed with the first waveguide 404 and is extended from the third region 404e of the first waveguide 404, so that the TE mode of the incident light beam Lᵢₙ propagates along the first direction D1 through the waveguide coupler 200, the waveguide transition 300, the combined section 402 and the first waveguide 404 and exists at the first port 501 as an output light Lₒᵤₜ. The first port 501 can be made of silicon. The first port 501 has a thickness T6, which may be substantially identical to the thickness T4 of the combined section 402 and thus is thicker than the thickness T5 of the splitting section. In some embodiments, the ratio of T5 to T6 is from about 1:2.7 to about 1:1.2. In some embodiments, the ratio of T5 to T6 is from about 1:2.5 to about 1:1.5. In some embodiments, the ratio of T5 to T6 is from about 1:2.0 to about 1:1.8. In some embodiments, the thickness T6 of the first port 501 may range from about 200 nm to about 350 nm. In some embodiments, the thickness T6 of the first port 501 may range from about 220 nm to about 320 nm. In some embodiments, the thickness T6 of the first port 501 may range from about 250 nm to about 300 nm. In some embodiments, the thickness T6 of the first port 501 may range from about 270 nm to about 290 nm.

The second port 502 is integrally formed with the second waveguide 406 and is extended from the fourth region 406g of the second waveguide 406, so that the TM mode of the incident light beam Lᵢₙ propagates along the first direction D1 through the waveguide coupler 200 and the waveguide transition 300, is converted to the TE₁ mode in the combined section 402 and converted to output TE mode Lₒᵤₜ in the second waveguide 406, which exists at the second port 502. The second port 502 can be made of silicon. The second port 502 has a thickness T7, which may be substantially identical to the thickness T4 of the combined section 402 and also substantially identical to the thickness T6 of the first port 501 and thus is thicker than the thickness T5 of the splitting section. In some embodiments, the ratio of T5 to T7 is from about 1:2.7 to about 1:1.2. In some embodiments, the ratio of T5 to T7 is from about 1:2.5 to about 1:1.5. In some embodiments, the ratio of T5 to T7 is from about 1:2.0 to about 1:1.8. In some embodiments, the thickness T7 of the second port 502 may range from about 200 nm to about 350 nm. In some embodiments, the thickness T7 of the second port 502 may range from about 220 nm to about 320 nm. In some embodiments, the thickness T7 of the second port 502 may range from about 250 nm to about 300 nm. In some embodiments, the thickness T7 of the second port 502 may range from about 270 nm to about 290 nm.

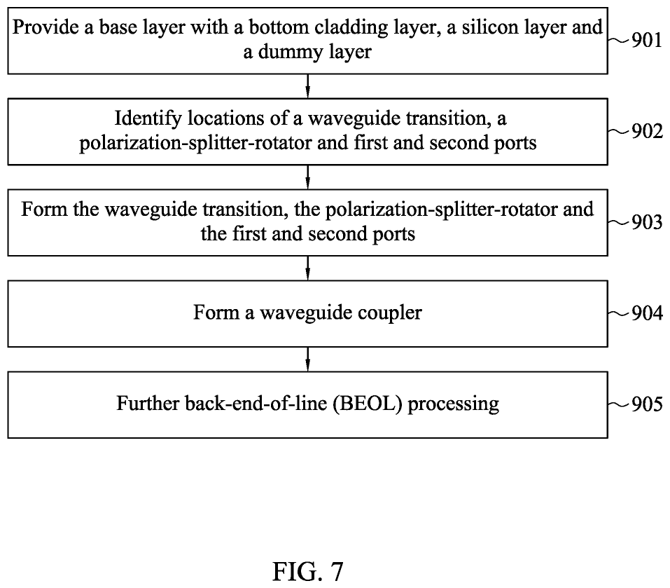

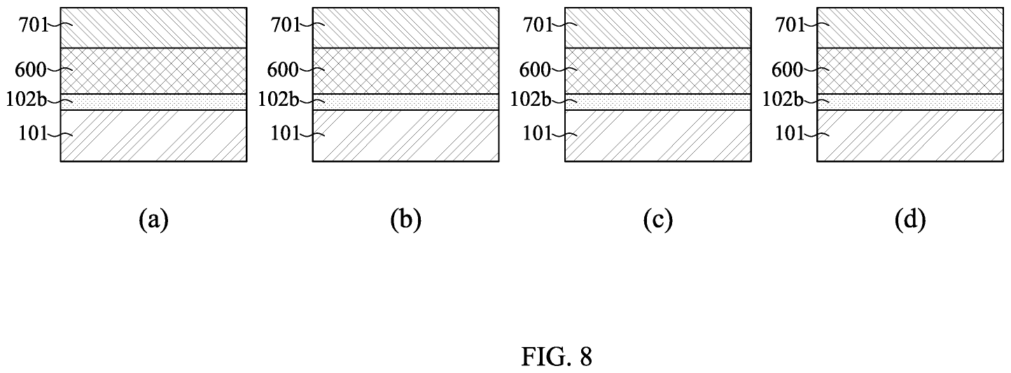

FIG. 7 is a flow chart of a method 900 for manufacturing a photonic structure according to various aspects of the present disclosure. The method 900 includes a number of operations (901, 902, 903, 904 and 905). The method for manufacturing the photonic structure 900 will be further described according to one or more embodiments. It should be noted that the operations of the method for manufacturing the photonic structure 900 may be rearranged or otherwise modified within the scope of the various aspects. It should further be noted that additional processes may be provided before, during, and after the method 900, and that some other processes may only be briefly described herein. Thus, other implementations are possible within the scope of the various aspects described herein. The operations of the method 900 in FIG. 7, including any descriptions given with reference to FIGS. 8 to 24, are merely exemplary and are not intended to be limiting beyond what is specifically recited in the claims that follow. In each of FIGS. 8 to 24, four figures are provided to illustrate the cross-sectional views (a) to (d) corresponding to the cross-section along line B-B′, line C-C′, line D-D′ and line E-E′, respectively, as shown in FIG. 1.

With reference to FIG. 8, the method 900 begins at operation 901 where a base layer 101 with a first cladding layer 102b as a bottom cladding layer, a silicon layer 600 and a dummy layer 701 is provided or received. The base layer 101 is usually a wafer made of a semiconducting material. Such materials can include silicon, for example in the form of crystalline Si or polycrystalline Si. The substrate can also be made from other elementary semiconductors such as germanium or Al₂O₃ (sapphire), or may include a compound semiconductor such as silicon carbide (SiC), gallium nitride (GaN), gallium arsenide (GaAs), indium arsenide (InAs), and indium phosphide (InP), or from other materials such as glass, a ceramic, or a dielectric material. The base layer 101 can be planarized through a chemical mechanical polishing (CMP) procedure.

The first cladding layer 102b can be formed over the base layer 101 and may be made of an insulation material including an oxide, such as silicon oxide, a nitride, such as silicon nitride, the like, or a combination thereof, which may be formed by a chemical vapor deposition (CVD) process, such as high-density plasma CVD (HDP-CVD), flowable chemical vapor deposition (FCVD), the like, or a combination thereof. Other insulation materials formed by any acceptable process may be used. In some embodiments, the insulation material is silicon oxide formed by FCVD. Although the first cladding layer 102b is illustrated as a single layer, some embodiments may utilize multiple layers. The first cladding layer 102b can be planarized through a chemical mechanical polishing (CMP) procedure.

The silicon layer 600 is formed over the first cladding layer 102b before forming the dummy layer 701. The dummy layer 701 is formed over the silicon layer 600 and may include a nitride, such as silicon nitride (SiNₓ) (e.g., as Si₃N₄).

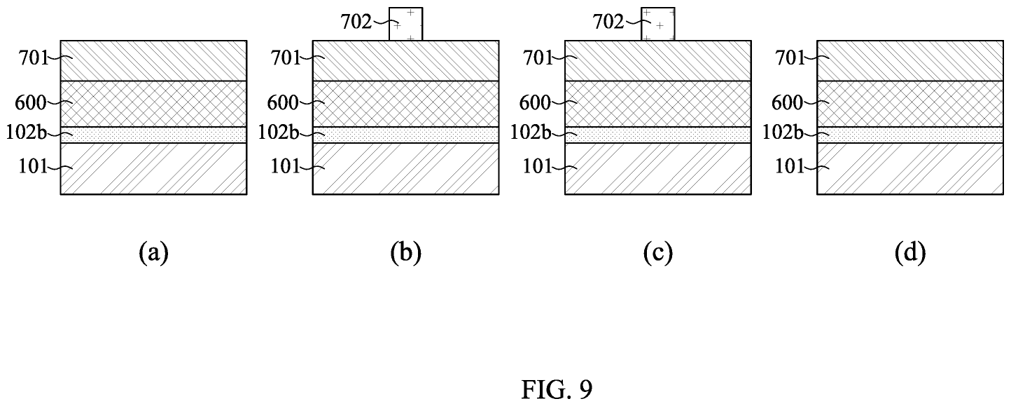

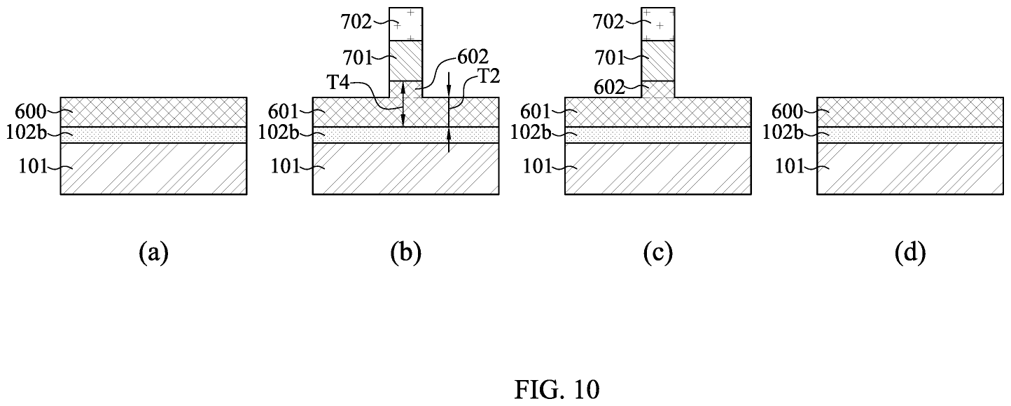

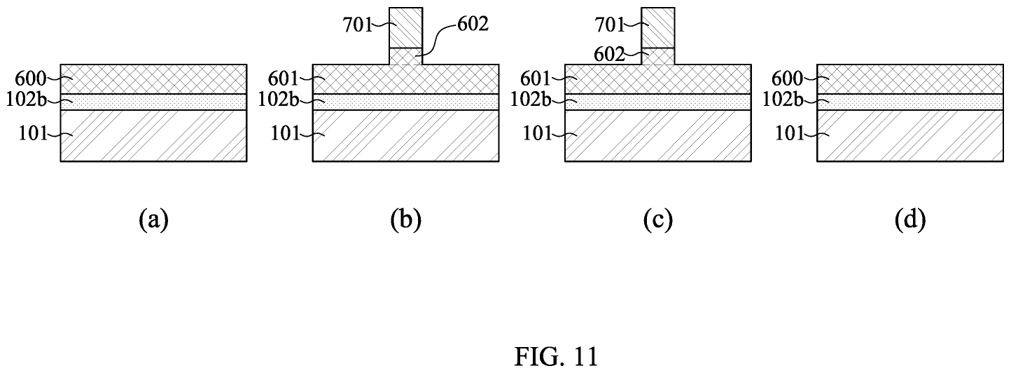

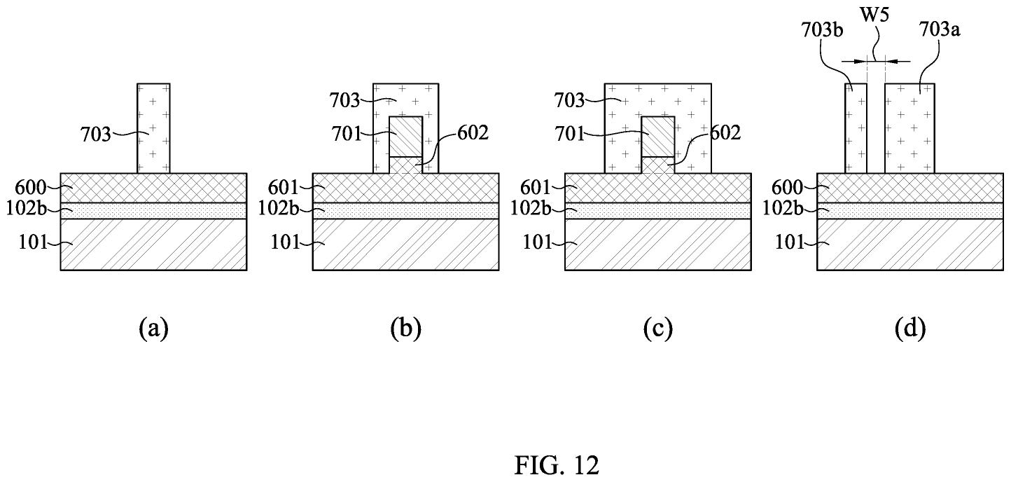

The method 900 continues with operation 902 where locations of a waveguide coupler 200, a waveguide transition 300, a polarization-splitter-rotator 400 and first and second ports 501 and 502 are identified. The operation 902 may include further operations. For example, a first patterned photoresist 702 is formed on the location for a combined section 402 of the polarization-splitter-rotator 400 as shown in FIG. 9 and also on the location for the first and second ports 501 and 502 (not shown). The dummy layer 701 and an upper portion of the silicon layer 600 exposed through the first patterned photoresist 702 are moved as shown in FIG. 10. The first patterned photoresist 702 is removed as shown in FIG. 11. A second patterned photoresist 703 is formed over the silicon layer 600 and the remaining dummy layer 701 as shown in FIG. 12.

Referring to FIG. 10, the operation of removing the dummy layer 701 and the upper portion of the silicon layer 600 exposed through the first patterned photoresist 702 makes the thickness T4 of the combined section 402 of the polarization-splitter-rotator 400 to be formed, the thickness T6 of the first port 501 to be formed, and the thickness T7 of the second port 502 to be formed thicker than the thicknesses T2 of the waveguide transition 300 and the thickness T5 of the splitting section of the polarization-splitter-rotator 400 to be formed. The silicon layer 600 shown in cross sectional views as illustrated in FIG. 10(b) and FIG. 10(c) is present in an inverted T shape and thus has a bottom portion 601 and an upper portion 602 protruding from the bottom portion 601. The remaining dummy layer 701 is retained on the upper portion 602 and the sidewall of the remaining dummy layer 701 is aligned with the sidewall of the upper portion 602.

Referring to FIG. 12, the patterned second photoresist 703 defines the locations of the waveguide transition 300, the polarization-splitter-rotator 400 and the first and second ports 501 and 502. In some embodiments, The second photoresist is formed over the silicon layer 600 and surrounds the upper portion 602 and the remaining dummy layer 701; and then is patterned to partially expose portions the silicon layer 600 as shown in FIG. 12(a) to FIG. 12(d) thereby defining the locations of the waveguide transition 300, the polarization-splitter-rotator 400 and the first and second ports 501 and 502 to be formed. In FIG. 12(d), the second patterned photoresist 703 is patterned to form a wide portion 703a for forming the first waveguide 404 and a narrow portion 703b for forming the second waveguide 406. The wide portion 703a is separated from the narrow portion 703b by a width W5.

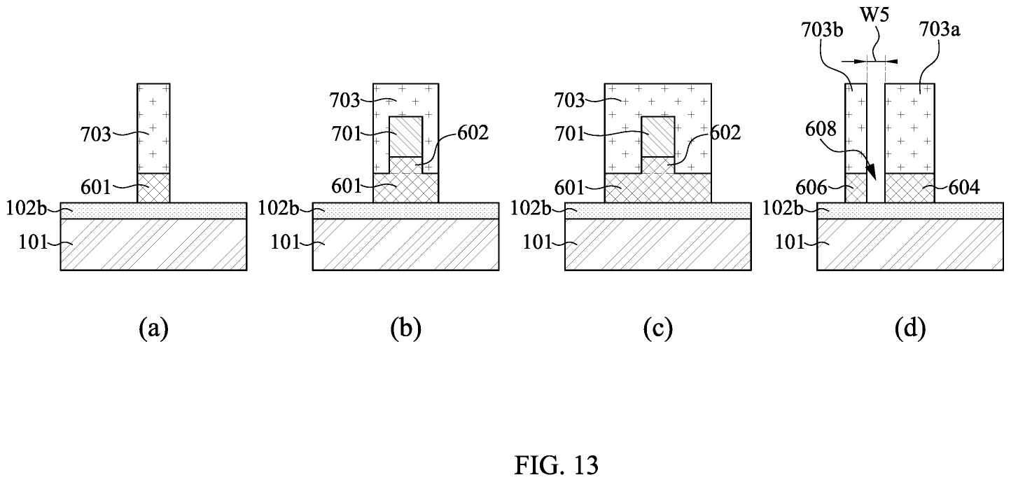

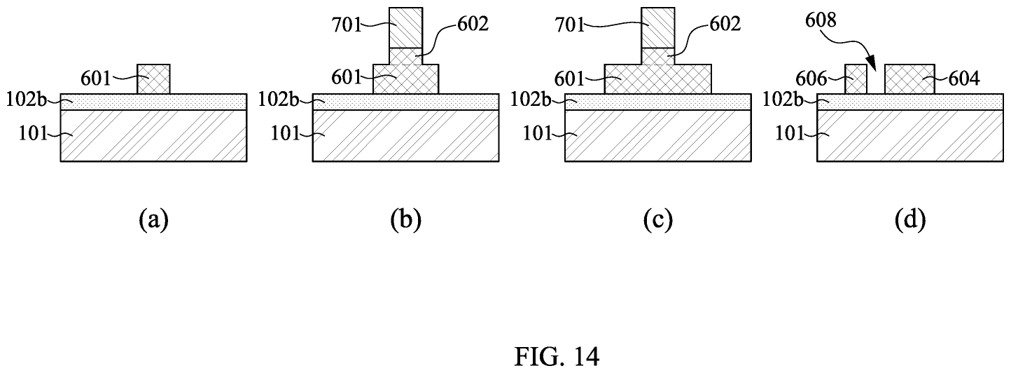

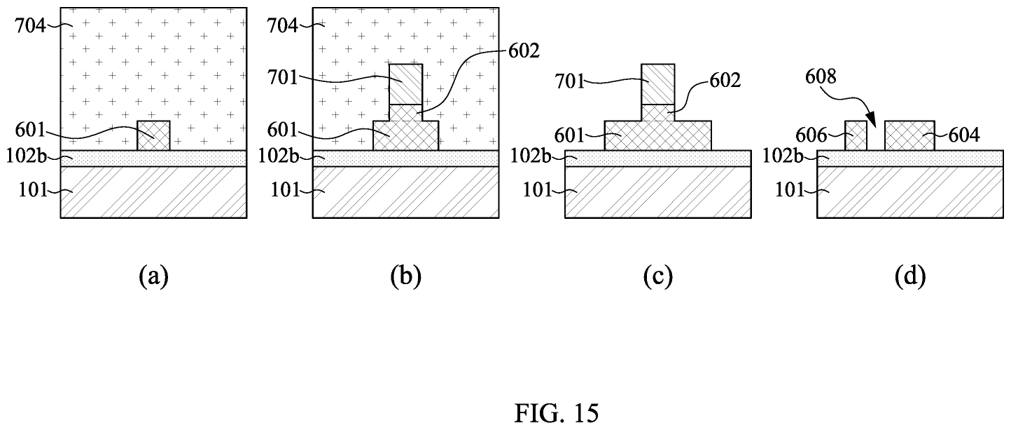

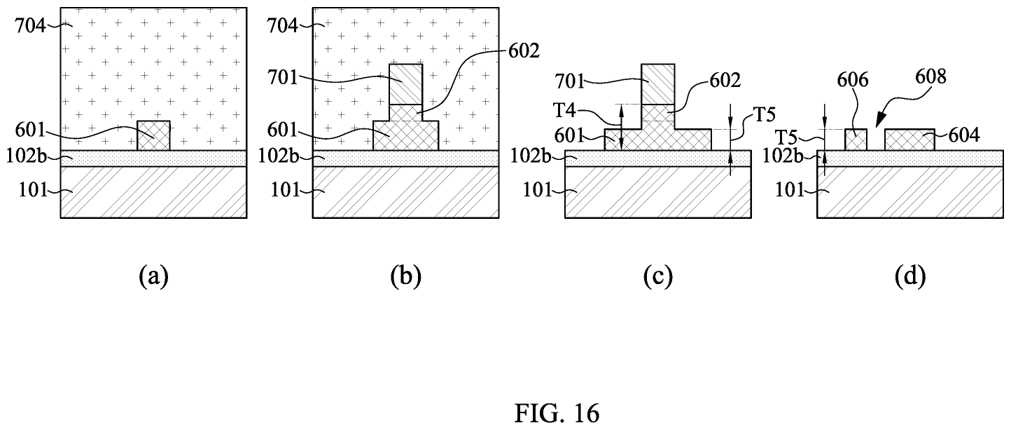

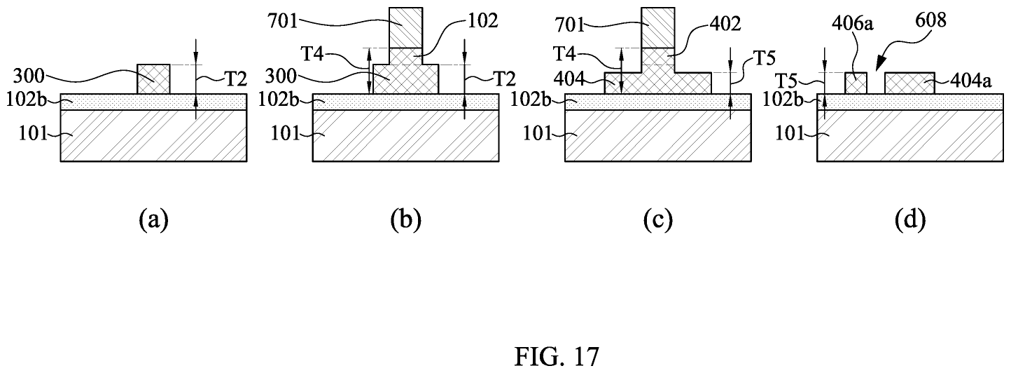

At operation 903, the waveguide transition 300, the polarization-splitter-rotator 400 (including the combined section 402 and the splitting section), and the first and second ports 501 and 502 are formed by removing the silicon layer 600 exposed through the second patterned photoresist 703 as shown in FIG. 13. The second patterned photoresist 703 is removed as shown in FIG. 14. A third patterned photoresist 704 is formed. The third patterned photoresist 704 exposes the splitting section of the polarization-splitter-rotator 400, the first port and the second port as shown in FIG. 15. Portions of the silicon layer 600 exposed through the third patterned photoresist 704 are removed. Accordingly, the thickness T5 of the splitting section is reduced, as shown in FIG. 16. The third patterned photoresist 704 is removed, as shown in FIG. 17.

The silicon layer 600 can be separated into two portions as shown in FIG. 13(d), a wider portion 604 for forming the first waveguide 404 and a narrow portion 606 for forming the second waveguide 406, which are separated through a slit 608 with the width W5. Referring to FIG. 17, the thickness T4 of the combined section 402 of the polarization-splitter-rotator 400 is greater than the thicknesses T2 of the waveguide transition 300 while the thicknesses T2 of the waveguide transition 300 is greater than the thickness T5 of the splitting section of the polarization-splitter-rotator 400. Although it is not shown in the figures, the thickness T6 of the first port 501 and the thickness T7 of the second port 502 are substantially identical to the thickness T4 of the combined section 402 of the polarization-splitter-rotator 400.

With reference to FIG. 17(c) and FIG. 17(d), portions of the bottom portion 601 of the exposed silicon layer 600 are removed to decrease the thickness T5 of the splitting section, so that the thickness T5 of the splitting section is less than the thickness of the silicon layer 600 covered by the third patterned photoresist 704 as shown in FIG. 17(a) and FIG. 17(b).

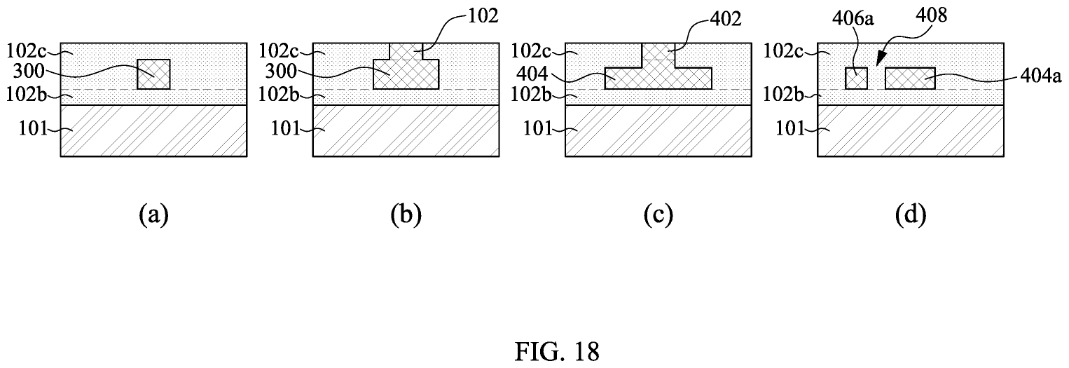

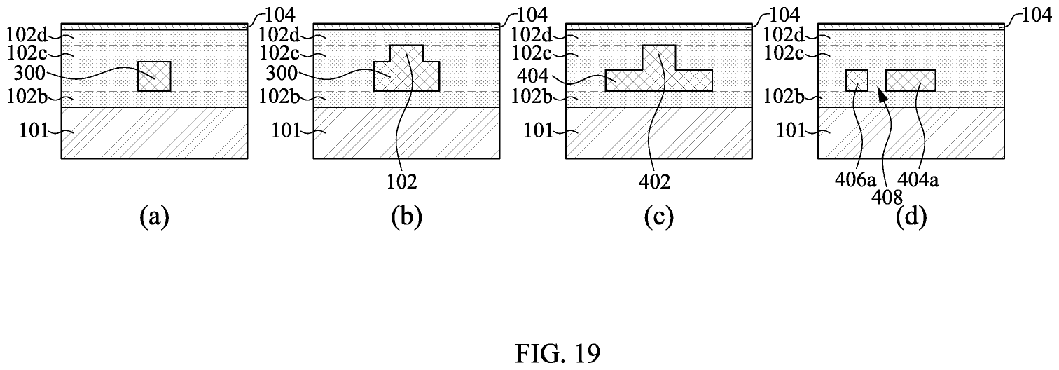

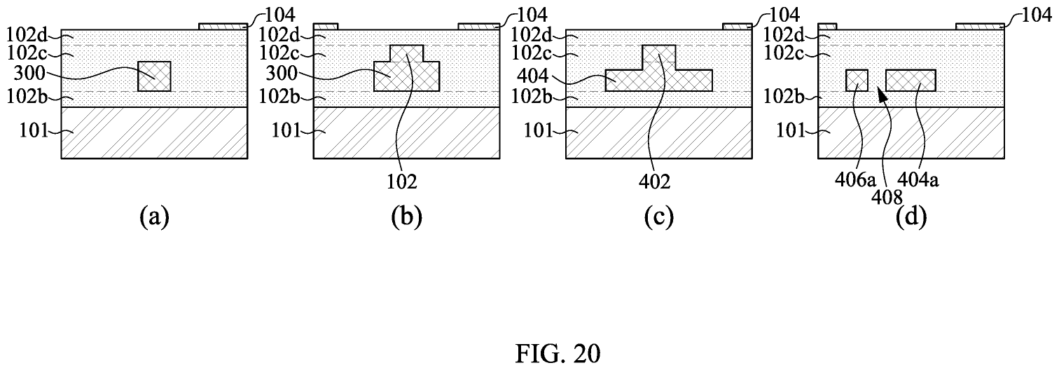

At operation 904, as shown in FIGS. 18 to 22, a waveguide coupler 200 is formed over a portion of the waveguide transition 300. In some embodiments, the forming of the waveguide coupler 200 includes further operations. For example, a second cladding layer 102c is formed. In some embodiments, a portion of the second cladding layer 102c dummy layer 701 remaining on the top of the combined section 402 (as shown in FIG. 17) are removed. In some embodiments, such removal includes a chemical mechanical polishing (CMP) operation. Accordingly, a top of the second cladding layer 102c is aligned with a top of the combined section 402. A third cladding layer 102d is formed on the second cladding layer 102c and the top of the combined section 402, and a contact-etch-stop layer (CESL) 104 is formed on the third cladding layer 102d as shown in FIG. 19. The CESL 104 is patterned to expose the waveguide transition 300, the polarization-splitter-rotator 400 and the first and second ports 501 and 502, as shown in FIG. 20.

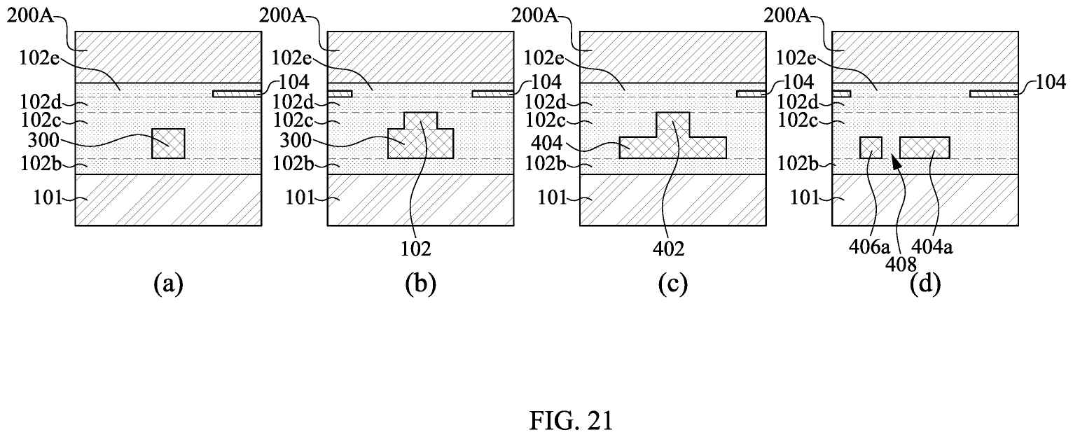

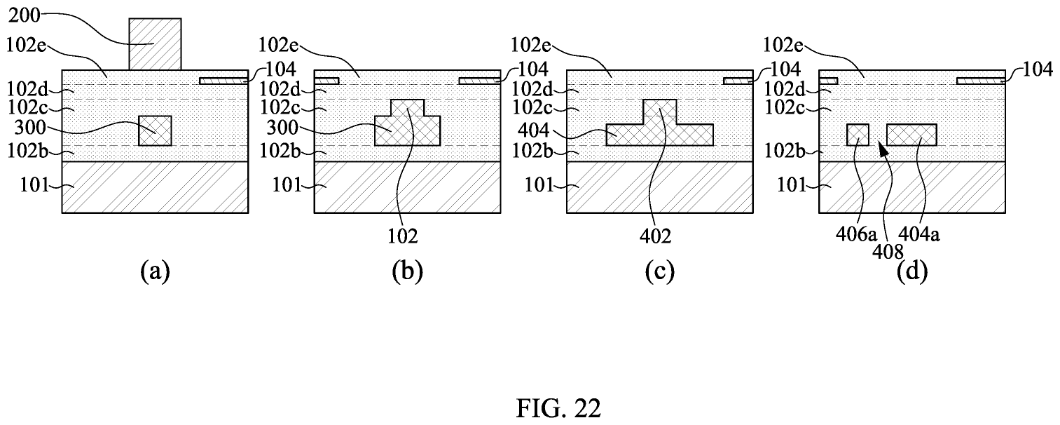

A fourth cladding layer 102e is formed on and between the CESL 104, and a material 200A for forming a waveguide coupler 200 is formed over the fourth cladding layer 102e, as shown in FIG. 21. In some embodiments, the material 200A is patterned to form the waveguide coupler 200 using suitable photolithography techniques as shown in FIG. 22, so that a portion of the second cladding layer 102c, the third cladding layer 102d and the fourth cladding layer 102e form a cladding interlayer 102a (as shown in FIG. 2A) sandwiched between the waveguide coupler 200 and the waveguide transition 300.

Referring back to FIG. 18, since the thickness T5 of the splitting section is decreased, the second cladding layer 102c can be sufficiently filled in the slit 608 so as to form a connecting strip 408 between the first waveguide 404 and second waveguide 406.

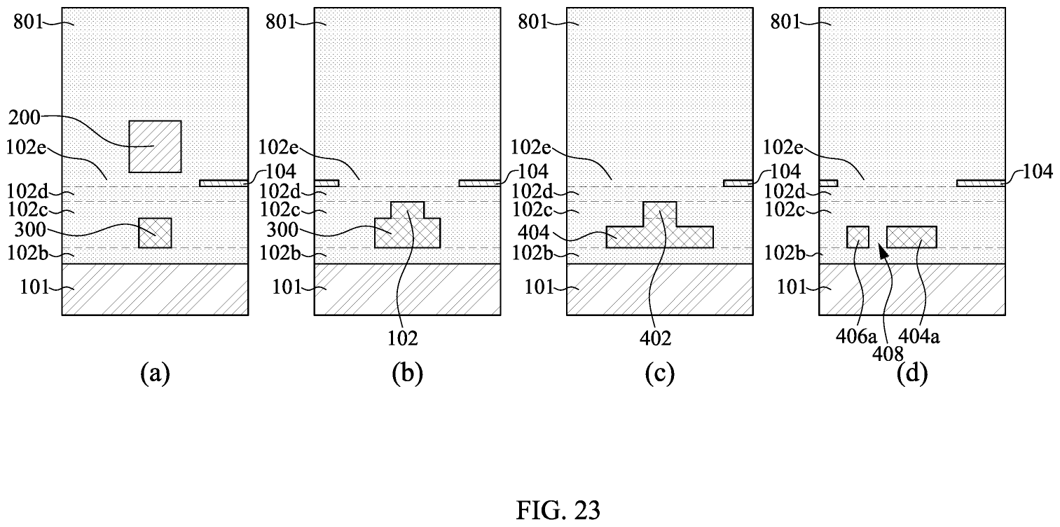

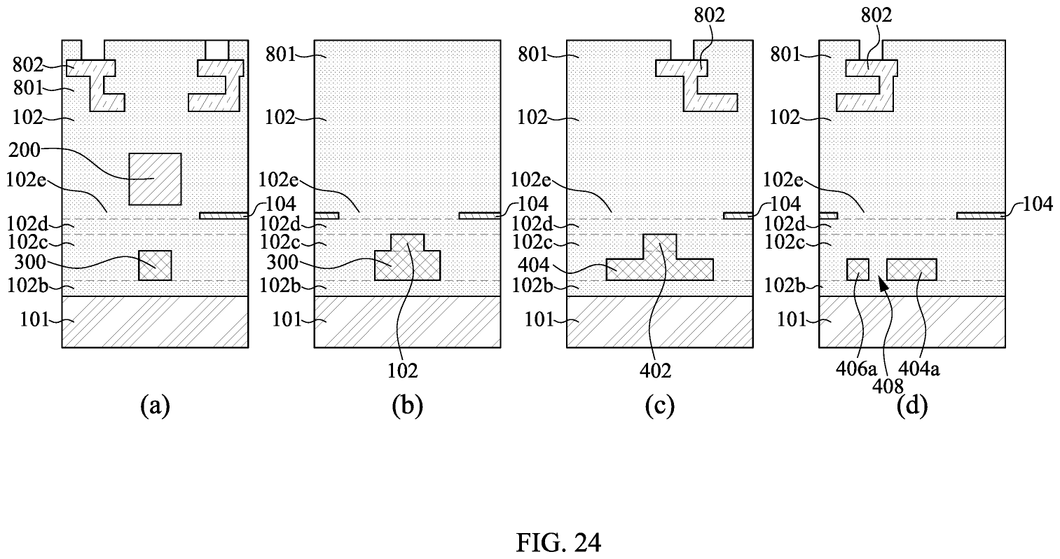

At operation 905, as shown in FIGS. 23 and 24, further back-end-of-line (BEOL) processing may be performed including forming an interlayer dielectric layer/inter-metal dielectric layer (ILD/IMD) 801 as shown in FIG. 23, and forming metal lines 802 in the ILD/IMD layer 801 as shown in FIG. 24. The ILD/IMD layer 801 may be, for example, silicon dioxide, silicon nitride, a low κ dielectric, some other dielectric, or a multi-layer film comprising a combination of the foregoing. As used herein, a low-κ dielectric is a dielectric with a dielectric constant κ less than about 3.9. In some embodiments, the material for forming the ILD/IMD layer 801 may be identical to the material for forming the cladding layer 102.

The dimension and shape of each of the waveguide coupler 200, the waveguide transition 300, the polarization-splitter-rotator 400 and the first and second ports 501 and 502 would influence the propagation of incident light. In the present invention, the length, thickness and shape of each of them are design to eliminate the loss of photons. Moreover, since the first waveguide 404 and second waveguide 406 of the splitting section are separated, the transmission of photons in the connecting strip 408 formed between two waveguides 404 and 406 should be smooth. It is critical to keep the aspect ratio of the connecting strip 408 formed between the first waveguide 404 and second waveguide 406 low to eliminate the presence of voids in the connecting strip 408.

In some embodiments, a photonic structure comprises a cladding layer; a waveguide coupler surrounded by the cladding layer; a waveguide transition surrounded by the cladding layer and formed underneath the waveguide coupler; a polarization-splitter-rotator surrounded by the cladding layer, extended from the waveguide transition along a first direction and comprising a combined section extended from the waveguide transition and having a symmetric shape from a top view; and a splitting section extended from the combined section, having an asymmetric shape from the top view and comprising a first waveguide extended from the combined section; and a second waveguide separated from the first waveguide by the cladding layer; and a first port and a second port surrounded by the cladding layer and respectively extended from the first waveguide and the second waveguide, wherein a thickness of the splitting section is less than a thickness of the combined section, less than a thickness of the first port and less than a thickness of the second port.

In some embodiments, a photonic structure comprises a cladding layer; a waveguide coupler surrounded by the cladding layer; a waveguide transition surrounded by the cladding layer and partially formed underneath the waveguide coupler; a polarization-splitter-rotator surrounded by a cladding layer, extended from the waveguide transition along a first direction and comprising a combined section extended from the waveguide transition and having a symmetric shape from a top view; and a splitting section extended from the combined section, having an asymmetric shape from the top view and comprising a first waveguide extended from the combined section; a second waveguide separated from the first waveguide by the cladding layer; and a connecting strip formed between the second waveguide and the first waveguide and having a narrowest width, wherein a material of the connecting strip is same as a material of the cladding layer; and two ports surrounded by the cladding layer and respectively extended from the first waveguide and the second waveguide, wherein a ratio of the narrowest width of the connecting strip to a thickness of the splitting section is from about 2:1 to 1:2.

In some embodiments, a method for manufacturing a photonic structure, comprising: forming a silicon layer and a dummy layer over a cladding layer; removing portions of the dummy layer and portions of an upper portion of the silicon layer; patterning the silicon layer to form a waveguide transition, a combined section and a splitting section of a polarization-splitter-rotator, and a first port and a second port; reducing a thickness of the splitting section of the polarization-splitter-rotator.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A photonic structure comprising:
a cladding layer;
a waveguide coupler surrounded by the cladding layer;
a waveguide transition surrounded by the cladding layer and formed underneath the waveguide coupler;
a polarization-splitter-rotator surrounded by the cladding layer, extended from the waveguide transition along a first direction and comprising:
a combined section extended from the waveguide transition and having a symmetric shape from a top view; and
a splitting section extended from the combined section, having an asymmetric shape from the top view and comprising:
a first waveguide extended from the combined section; and
a second waveguide separated from the first waveguide by the cladding layer; and
a first port and a second port surrounded by the cladding layer and respectively extended from the first waveguide and the second waveguide,
wherein a thickness of the splitting section is less than a thickness of the combined section, less than a thickness of the first port, and less than a thickness of the second port.

2. The photonic structure of claim 1, wherein a ratio of the thickness of the splitting section to the thickness of the combined section is from about 1:3 to about 1:1.1.

3. The photonic structure of claim 1, wherein the thickness of the first port is substantially identical to the thickness of the second port, and the thickness of the first port and the thickness of the second port are substantially identical to the thickness of the combined section.

4. The photonic structure of claim 1, wherein a thickness of the waveguide transition is less than the thickness of the combined section and is greater than the thickness of the splitting section; and wherein the thickness of the combined section ranges from about 200 nm to about 350 nm.

5. The photonic structure of claim 1, wherein a ratio of the thickness of the splitting section to a thickness of the waveguide transition is from about 1:2.5 to about 1:1.

6. The photonic structure of claim 1, wherein the waveguide transition is separated from the waveguide coupler along a second direction perpendicular to the first direction by a distance, and the distance is less than a thickness of the waveguide transition.

7. The photonic structure of claim 6, wherein a ratio of the thickness of the waveguide transition to the distance between the waveguide transition and the waveguide coupler is from about 10:1 to 1.5:1.

8. The photonic structure of claim 1, wherein the cladding layer includes oxide, the waveguide coupler includes silicon nitride, and the waveguide transition, the polarization-splitter-rotator, the first port and the second port include silicon.

9. A photonic structure comprising:
a cladding layer;
a waveguide coupler surrounded by the cladding layer;
a waveguide transition surrounded by the cladding layer and partially formed underneath the waveguide coupler;
a polarization-splitter-rotator surrounded by the cladding layer, extended from the waveguide transition along a first direction, and comprising:
a combined section extended from the waveguide transition and having a symmetric shape from a top view; and
a splitting section extended from the combined section, having an asymmetric shape from the top view and comprising:
a first waveguide extended from the combined section;
a second waveguide separated from the first waveguide by the cladding layer; and
a connecting strip formed between the second waveguide and the first waveguide and having a narrowest width, wherein a material of the connecting strip is same as a material of the cladding layer; and
two ports surrounded by the cladding layer and respectively extended from the first waveguide and the second waveguide,
wherein a ratio of the narrowest width of the connecting strip to a thickness of the splitting section is from about 2:1 to 1:2.

10. The photonic structure of claim 9, wherein a ratio of the thickness of the splitting section to thicknesses of the ports is from about 1:2.7 to about 1:1.2.

11. The photonic structure of claim 9, wherein a thickness of the combined section is greater than the thickness of the splitting section; and wherein the thickness of the combined section ranges from about 200 nm to about 350 nm.

12. The photonic structure of claim 9, wherein thicknesses of the ports are substantially identical to a thickness of the combined section; the thicknesses of the ports are greater than the thickness of the splitting section; and the thickness of the combined section is greater than the thickness of the splitting section.

13. The photonic structure of claim 9, wherein
the waveguide transition has a thickness, which is greater than the thickness of the splitting section, and the thickness of the waveguide transition ranges from about 170 nm to about 250 nm; and
the waveguide coupler has a thickness and a ratio of the thickness of the waveguide transition to the thickness of the waveguide coupler is from about 1:5 to about 1:1.1.

14. The photonic structure of claim 13, wherein
the first waveguide comprises:
a distal end connecting the combined section;
a proximal end connecting one of the two ports;
a first turn;
a second turn;
a first region defined between the distal end and the first turn;
a second region defined between the first turn and the second turn; and
a third region defined between the second turn and the proximal end; and
the second waveguide comprises:
a distal end and a proximal end;
a first turn;
a second turn;
a third turn;
a first region defined between the distal end and the first turn;
a second region defined between the first turn and the second turn;
a third region defined between the second turn and third turn; and
a fourth region defined between the third turn and the proximal end.

15. The photonic structure of claim 9, wherein a thickness of the combined section ranges from about 200 nm to about 350 nm; and the narrowest width of the connecting strip ranges from about 50 nm to about 200 nm.

16. A method for manufacturing a photonic structure, comprising:
forming a silicon layer and a dummy layer over a cladding layer;
removing portions of the dummy layer and portions of an upper portion of the silicon layer;
patterning the silicon layer to form a waveguide transition, a combined section and a splitting section of a polarization-splitter-rotator, and a first port and a second port; and
reducing a thickness of the splitting section of the polarization-splitter-rotator.

17. The method of claim 16, further comprising forming a waveguide coupler over a portion of the waveguide transition.

18. The method of claim 16, further comprising forming a patterned a contact-etch-stop layer (CESL) exposing the waveguide transition, the polarization-splitter-rotator and the first port and the second port.

19. The method of claim 16, wherein a thickness of the splitting section is less than a thickness of the combined section.

20. The method of claim 16, wherein a thickness of the waveguide transition is less than a thickness of the combined section and is greater than a thickness of the splitting section.
